(19) United States
(12) Patent Application Publication
(10) Pub. No.: US 2011/0161253 A1
(43) Pub. Date: Jun. 30, 2011

(54) SYSTEMS AND METHODS FOR MANAGING SOCIAL INTERNETWORK SERVICES

(76) Inventors: Moses Ma, Mill Valley, CA (US); Robert David Bressler, Saint Helena, CA (US); William Norman Simpson, Franklin, TN (US)

(21) Appl. No.: 12/979,713

(22) Filed: Dec. 28, 2010

Related U.S. Application Data
(60) Provisional application No. 61/290,566, filed on Dec. 29, 2009.

(51) Int. Cl. G06F 21/00; G06Q 90/00

(52) U.S. Cl. 705/500; 726/3

(57) ABSTRACT

A network service system provides services to a plurality of entities through a network. The system comprises at least one identity subsystem for managing identity information associated with the entities, at least one geographical information subsystem for managing information associated with geographical location of the entities, and at least one trust validation subsystem for authenticating the communication among the entities based on predefined preference. Further, the system comprises a network manager for communicating with one or more of the at least one identity subsystem, the at least one geographical location subsystem, the at least one trust validation subsystem and the plurality of entities to provide the services. The services may enable federation of the networks.

### CROSS-REFERENCE TO RELATED APPLICATION

This application draws priority from U.S. Provisional Patent Application No. 61/290,566, filed on Dec. 29, 2009, and hereby incorporated by reference herein in its entirety.

### FIELD OF THE INVENTION

The present invention relates generally to computer networks and more particularly to social computer networks where members of the network may interact in the context of content or activity.

### BACKGROUND OF THE INVENTION

Generally, various services are provided through networks such as communication, and data exchange. For example, an organization may include an internal network for its employees to share information or collaborate. Internal collaboration among various individuals within an organization is generally required for harnessing collective intelligence and creativity of groups. The collaboration enables envisioning of new ideas and reveals dormant knowledge. Various techniques are available for enabling collaboration, such as real-time talks, face-to-face conferences and so forth. However, the available technologies have fallen short in terms of handling the increasing complexity and demand in collaboration. Various computer-supported collaboration technologies provide enhanced collaboration capabilities. The computer-supported technologies include email, chat rooms, instant messaging, discussion forums, wiki's, voting response systems, and so forth. The computer-supported technologies further include social networks. A social network is an arrangement of various entities such as but not limited to, individuals, organizations, institutions and so forth. The entities may be connected through the social network based on various common interests or interdependencies such as friendship, activities, knowledge exchange and so forth. Various social network services exist that provide online services for enabling the entities to share the common interests. For example, each organization or enterprise may have its own social network for exchanging information among employees.

The computer-supported collaboration may be used for be used for anything from repetitive manual work to high value conceptual work such as brainstorming, coordination, collaborative decision, and so forth. However, the available computer-supported collaboration techniques may not be able to appropriately manage high value collaboration especially between organizations. In general, the internal social network of an enterprise is private from the internal social networks of another enterprise. As a result, collaboration between those enterprises is inhibited. Even with the proliferation of social networks, there still remain islands of communities that are both within existing organizations as well as between organizations and individuals. Communications between these communities has been limited to a flat, unstructured email environment.

In the light of the above discussion, techniques are desired for providing services in computer networks and social networks.

### SUMMARY

Embodiment of the invention may provide a network service system for providing services to a plurality of entities through a network. The system comprising: at least one identity subsystem configured to manage identity information associated with the plurality of entities; at least one geographical information subsystem configured to manage information associated with geographical location of the plurality of entities; and at least one trust validation subsystem configured to authenticate the communication among the plurality of entities based on predefined rules; and a network manager configured to communicate with one or more of the at least one identity subsystem, the at least one geographical location subsystem, the at least one trust validation subsystem and the plurality of entities to provide the services.

Embodiment of the invention may provide a system for federating a plurality of private computer networks. The system comprising: at least one identity subsystem configured to maintain identity information of a plurality of entities, wherein the plurality of entities are associated with at least one of the plurality of private computer networks, wherein the plurality of entities communicate through the plurality of private computer networks; at least one geographical information subsystem configured to maintain information associated with geographical location of the plurality of entities; and at least one trust validation subsystem configured to maintain an authentication of the plurality of entities, wherein the plurality of entities communicate among each other based on the identity information, geographical location and the authentication of the communication.

Embodiment of the invention may provide a network service system for providing services to a plurality of entities through a network. The system comprising: at least one identity subsystem configured to manage identity information associated with the plurality of entities; at least one geographical information subsystem configured to manage information associated with geographical location of the plurality of entities; and at least one trust validation subsystem configured to authenticate the communication among the plurality of entities based on predefined preferences of the entities; and at least one processor; and a memory comprising instructions executable by the at least one processor, the instructions comprising: receiving communication from a first entity from the plurality of entities for a second entity from the plurality of entities; determining identity information of the second entity from the identity subsystem; determining information associated with geographical location of the second entity from the geographical location subsystem; authenticating, by the at least one trust subsystem, the communication from the first entity for the second entity, based on the determined identity information, geographical location and predefined preferences of the second entity; and transmitting the communication to the second entity based on the authentication.

Embodiment of the invention may provide a system for federating a plurality of private computer networks. The system comprising: at least one identity subsystem configured to maintain identity information of a plurality of entities, wherein the plurality of entities are associated with at least one of the plurality of private computer networks, wherein the plurality of entities communicate through the plurality of private computer networks; at least one geographical location subsystem configured to maintain information associated with geographical location of the plurality of entities; at least one trust validation subsystem configured to maintain an authentication of the plurality of entities; at least one processor; and a memory comprising instructions executable by the at least one processor, the instructions comprising: receiving communication from a first entity from the plurality of entities for a second entity from the plurality of entities; determining identity information of the second entity from the identity subsystem; determining information associated with geographical location of the second entity from the geographical location subsystem; authenticating, by the at least one trust subsystem, the communication from the first entity for the second entity, based on the determined identity information, geographical location and predefined preferences of the second entity; and transmitting the communication to the second entity based on the authentication.

Embodiment of the invention may provide a federated computer network. The federated computer network comprising: a plurality of private computer networks, wherein each of the plurality of computer networks comprise a plurality of entities; at least one identity subsystem configured to maintain identity information of the plurality of entities; at least one geographical location subsystem configured to maintain information associated with geographical location of the plurality of entities; at least one trust validation subsystem configured to authenticate the communication among the plurality of entities based on predefined rules; and a network manager configured to enable communication among the plurality of entities associated with one or more of the plurality of private computer networks, based on information received from one or more of the at least one identity subsystem, the at least one geographical location subsystem, and the at least one trust validation subsystem.

Embodiment of the invention may provide a computer-implemented method for federating a plurality of private computer networks. The method comprising: receiving from a first entity in a first private computer network a communication destined to a second entity in a second private computer network; determining, at an identity subsystem, identity information associated with the second entity; determining, at a geographical location subsystem, geographical location information associated with the second entity; and authenticating, at a trust subsystem, the communication from the first entity; and transmitting the communication to the second entity based on the identity information, geographical location information and the authentication of the communication.

Embodiment of the invention may provide a federated computer network. The federated computer network comprising: a plurality of private computer networks, wherein each of the plurality of computer networks comprise a plurality of entities; at least one identity subsystem configured to maintain identity information of the plurality of entities; at least one geographical location subsystem configured to maintain information associated with geographical location of the plurality of entities; at least one trust validation subsystem configured to authenticate the communication among the plurality of entities based on predefined rules; and a network manager configured to enable communication among the plurality of entities to allow electronic addressing by at least one of a physical location, a title, a position, one or more areas of interest, or a group affiliation of an entity from the plurality of entities. The services may include tracking and verification of electronic and geographical addresses of the plurality of entities.

Embodiment of the invention may provide a federated computer network. The federated computer network comprising: a plurality of private computer networks, wherein each of the plurality of computer networks comprise a plurality of entities; at least one identity subsystem configured to maintain identity information of the plurality of entities; at least one geographical location subsystem configured to maintain information associated with geographical location of the plurality of entities; at least one trust validation subsystem configured to authenticate the communication among the plurality of entities based on predefined rules; and a network manager configured to enable at least one or an identity management, an access management, a plurality of levels of trust, authentication, or exchange and/or trade of trust objects and markers of the plurality of entities. In an embodiment of the invention, controls can be provided to limit and/or enhance the levels of trust and/or communications.

Embodiment of the invention may provide a federated computer network. The federated computer network comprising: a plurality of private computer networks, wherein each of the plurality of computer networks comprise a plurality of entities; at least one identity subsystem configured to maintain identity information of the plurality of entities; at least one geographical location subsystem configured to maintain information associated with geographical location of the plurality of entities; at least one trust validation subsystem configured to authenticate the communication among the plurality of entities based on predefined rules; and a network manager configured to enable identification and/or management of the establishment of communities based on at least one of interests, a business type, or a geographical location of the plurality of entities to track a plurality of levels of trust and/or manage an eco-system of a plurality of trust objects and/or markers;

Embodiment of the invention may provide a federated computer network. The federated computer network comprising: a plurality of private computer networks, wherein each of the plurality of computer networks comprise a plurality of entities; at least one identity subsystem configured to maintain identity information of the plurality of entities; at least one geographical location subsystem configured to maintain information associated with geographical location of the plurality of entities; at least one trust validation subsystem configured to authenticate the communication among the plurality of entities based on predefined rules; and a network manager configured to enable intercommunications between the plurality of private computer networks, wherein the plurality of computer networks comprise disparate social networking clouds.

Embodiment of the invention may provide a method for delivering a physical package. The method comprising: receiving, from a sender, the physical package, wherein the physical package is addressed with an email address of a receiver; determining identity information of the receiver based on the email address; determining predefined preferences of the receiver based on the identity information; and delivering the physical package to the receiver based on the predefined preferences.

### BRIEF DESCRIPTION OF THE DRAWINGS

Having thus described the invention in general terms, reference will now be made to the accompanying drawings, which are not necessarily drawn to scale, and wherein:

FIG. 1 illustrates an exemplary environment where various embodiments of the invention function;

FIG. 2 illustrates a framework of a network service system, in accordance with an embodiment of the invention;

FIG. 3 illustrates an exemplary federated network comprising a network federation system, in accordance with an embodiment of the invention;

FIG. 4 illustrates another exemplary federated network, in accordance with an embodiment of the invention;

FIG. 5 is a flow diagram illustrating an electronic communication, in accordance with an embodiment of the invention;

FIG. 6 is a flowchart of a method for providing services in a network, in accordance with an embodiment of the invention; and

FIG. 7 is a flowchart of a method of delivering a physical package, in accordance with an embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

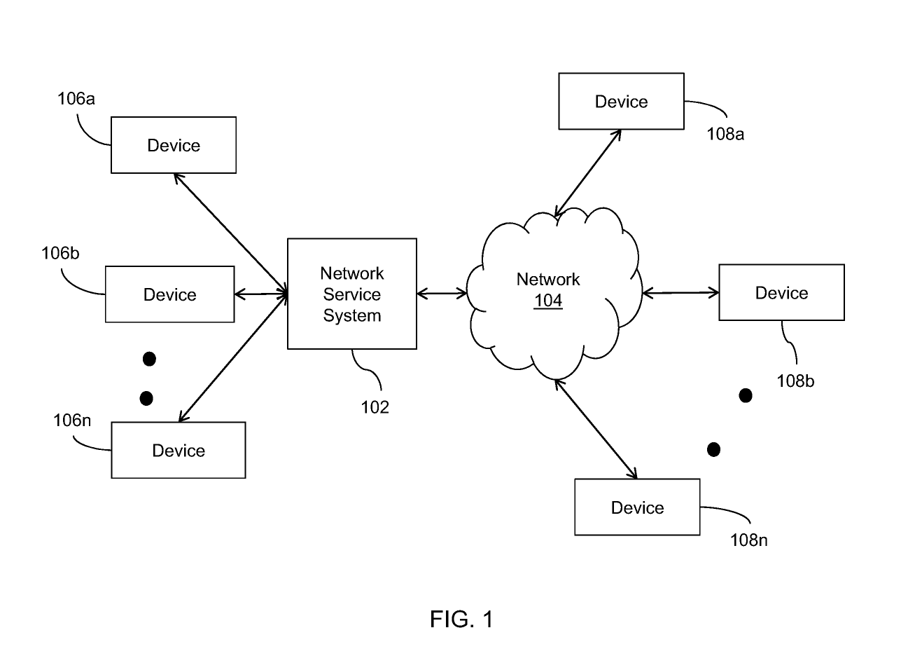

FIG. 1 illustrates an exemplary environment 100 where various embodiments of the invention may function. As shown, a Network Service System (NSS) 102 may be connected to multiple devices 106a-n, network 104, and devices 108a-n through network 104. Examples of network 104 include, but are not limited to, a Local Area Network (LAN), a Wide Area Network (WAN), or other wired or wireless networks. Examples of devices 106a-n and devices 108a-n include, but are not limited to, computers, servers, mobile phones, telephones, smartphones, Personal Desktop Assistants (PDAs) or other devices capable of data transfer. Devices 106a-n and devices 108a-n may form computer networks. For example, an organization may have an internal computer network that includes devices 106a-n. Further, the internal network of the organization may be a private network, which is not accessible to entities or uses outside the organization.

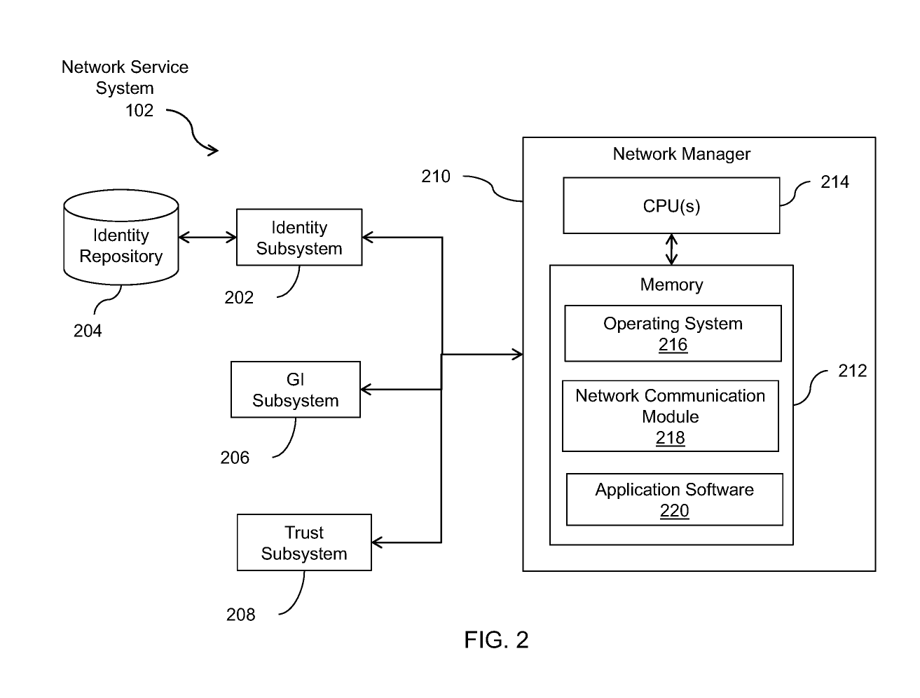

NSS 102 may provide various network services to entities that use devices 106a-n, network 104, and devices 108a-n. For examples, NSS 102 may provide identity services, geographical location services, trust services and so forth to the users. In an embodiment of the invention, NSS 102 may be implemented as a geographically distributed system of networked computers and/or servers and/or data repositories. The services provided by NSS 102 enable the entities to perform secure communication across internal or private networks. Further, the entities from different private networks may collaborate, exchange emails, exchange physical packages, manage marketing and/or advertisement campaigns and so forth based on the services from NSS 102. The framework of NSS 102 is explained in detail in conjunction with FIG. 2.

FIG. 2 illustrates a framework of NSS 102, in accordance with an embodiment of the invention. As shown, NSS 102 may include an identity subsystem 202. Identity subsystem 202 may include a computer or a server. In an embodiment of the invention, identity subsystem 202 may include a cloud of identity servers that provide information associated with identity of an entity. In case, an entity is a user, the information associated with the identity may include, but is not limited to, a name, one or more email address(es), name of the organization, and so forth. For example, for the entity with name “John T. Smith”, email address “john@abcbusiness.com”, a logical address may be maintained such as “john@123mainstreet.sanfrancisco.ca.us”, where “123 Mainstreet, Sanfrancisco, Calif., USA” may be the address of business of John. The identity information may be stored in an identity repository 204 connected to identity subsystem 202. In an embodiment of the invention, identity repository 204 may include information such as addresses of geographical location, title, position, areas of interest, or group affiliation for each entity. For example, areas of interest may include, but not limited to, news, sports, business, technology, law, entertainment and so forth. In an embodiment of the invention, multiple identity repositories that include similar information as in identity repository 204 may be implemented in the cloud of identity servers. In an embodiment of the invention, identity subsystem 202 may maintain a unique universal identifies for each entity. For example, as discussed above the unique universal identifier of John may be “John T. Smith rocket321”. In an embodiment of the invention, the unique universal identifiers may be created by the entities. In another embodiment of the invention, the unique universal identifiers may be automatically generated by identity subsystem 202. In yet another embodiment of the invention, these unique universal identifiers can be disposable, single use addresses usable only by a specific sender. Further, as shown the unique universal identifiers may be used for postal addresses. Therefore, the information can be retrieved from identity subsystem 202 by using the universal identifiers.

NSS 102 may further include Geographical Information Subsystem (GIS) 206. GIS 206 maintains and provides geographical location information related to the entities. For example, GIS 206 may maintain and provide maps, or coordinates of the address(es) of the entities. Further, GIS 206 may maintain and provide information such as, but not limited to, continent, country, state, county, zip codes and so forth. In an embodiment of the invention, the information in GIS 206 may be maintained based on the universal identifiers of the entities. GIS 206 may be implemented as a server. In an embodiment of the invention, GIS 206 may be implemented as a cloud of geographically distributed servers that provide the geographical information.

Trust subsystem 208 of NSS 102 may provide authentication of communication between the entities. For example, the communication may be electronic communication is the form of electronic messages such as emails, or files that may be shared among the entities. Trust subsystem 208 may be implemented as a computer or a server. In an embodiment of the invention, trust subsystem 208 may be implemented as a cloud of servers. For example, trust subsystem 208 may authenticate the communication by providing time and date for communication such as binding agreements and binding notices. Further, trust subsystem 208 may encrypt and/or verify the communication along with the timestamp. In an embodiment of the invention, trust subsystem 208 may verify the authentication of communication by checking various checksums or hash for archived files. Further, trust subsystem 208 may include a source of time to maintain time resolution. In an embodiment of the invention, trust subsystem 208 may provide trust object and markers that authenticate multiple relationship factors related to the entities and/or between the entities. Examples of trust object and markers may include, but are not limited to, digitally signed validations of working relationships, credit history, account balance estimates, college transcripts or graduation verifications, employment verifications, personal recommendations, and so forth. The requirement of authentication and trust may be explained with an exemplary scenario of a landlord and a prospective tenant. The landlord may perform a check on the prospective tenant for a residential apartment tenancy application by calling the bank holding the accounts of the prospective tenant and requesting information on which to build trust for the tenant. However, the caller may not be authenticated over the phone, the bank may not provide an exact account balance, but may provide less detailed information such as “this person has a four figure balance and has never bounced a check”. Therefore, even providing less detailed information may allow the prospective landlord to increase trust in the tenant, which however is a normal service of personal banking. In an embodiment of the invention, both the query and the response may be authenticated to increase security. Further, trust subsystem 208 could even require an explicit approval from an entity before releasing any personal information. In another embodiment of the invention, if the entity has several trust markers associated with the identity information (as held on identity repository 204), then identity subsystem 202 may provide a first pass trust information to authenticated communication by informing about the number and quality of the trust markers. For example, quality of the trust markers such as financial and security clearance information, as well as college and high school diplomas and honors, may be higher than the quality of trust markers such as personal references from social network friends.

NSS 102 may include a network manager 210 for enabling a federation among multiple computer networks. In an embodiment of the invention, network manager 210 may be implemented as a computer or a server in NSS 102. In another embodiment of the invention, the functionalities of network manager 210 may be distributed over multiple nodes in NSS 102 for distributed computing. Network manager 210 includes a memory 212 and one or more Central Processing Units (CPUs) 214. CPU(s) 214 may execute the instructions stored in memory 212. In an embodiment of the invention, multiple CPU(s) 214 may execute processes that may be a part of a master process in distributed computing. Examples of memory 212 include, but are not limited to, a Random Access Memory (RAM), a Read Only Memory (ROM), or any other disk based memory. Memory 212 may include an Operating System (OS) 216, a network communication module 218 and application software 220. Examples of OS 216 include, but are not limited to, Unix, Linux, Windows, Macintosh, and so forth.

Network communication module 218 enables network manager 210 to communicate on the network. Examples of network include, but are not limited to, Local Area Network (LAN), Wide Area Network (WAN), the Internet, or other wired or wireless networks. Application software 220 may execute on network manager 210 to provide the services. Examples of the services include, but are not limited to, include tracking, verification, and unification of the electronic and geographical addresses of the entities. Further, services may include identification and/or management of the establishment of communities (groups of entities) based on areas of interests, business, or geographical location; tracking of levels of trust and trading trust objects and markers; and enabling intercommunications between the private computer networks such as social networking clouds. In an embodiment of the invention, application software 220 may be a multiple process application that can be executed over distributed computing systems. For example, application software 220 may include a master process and multiple sub-processes, where the sub-processes may be executed on CPUs 214 distributed over a computing network. Application software 220 may receive communications from the entities in computer network and accordingly instruct CPUs 214 to process the communication for identity and/or geographical information and/or trust.

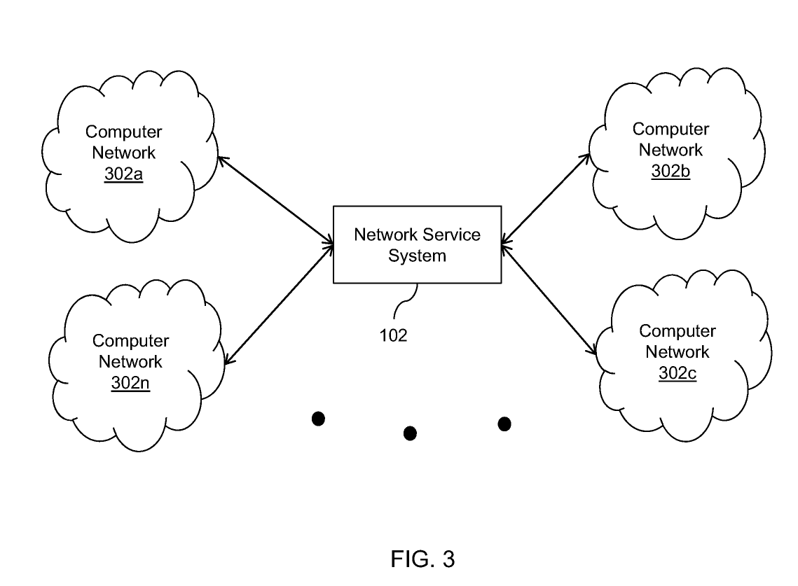

FIG. 3 illustrates an exemplary federated network 300 comprising network service system 102, in accordance with an embodiment of the invention. Federated network 300 may include multiple computer networks 302a-n. In an embodiment of the invention, computer networks 302a-n are private computer networks, therefore, direct communication may not be available among the private computer networks 302a-n. For example, computer networks 302a-n may be extranets or social networks of various entities such as organizations, institutions, individuals and so forth. NSS 102 enables communication between the entities of computer networks 302a-n and provides other services as discussed above. In an embodiment of the invention, one or more of computer networks 302a-n may include social networks and/or social network clouds. Examples of social networks include private social networks of an organization where only the employees of the organization can access them, or public social networks such as Facebook, Twitter, Orkut, MySpace and so forth.

In an embodiment of the invention, application software 220 may provide a graphical user interface for the entities to communicate and collaborate with each other. For example, the graphical user interface can be in form of a website or workspaces that can be mutually accessed by private computer networks. In an embodiment of the invention, the workspaces can be generated dynamically and provide a platform for the entities to share information with each other. Therefore, the workspaces can be created and terminated automatically. A static workspace may be a discussion forum that is created and persists between two organizations (or entities), while a dynamic workspace may be the agreement to create and delete forums or groups automatically. For example, a customer service forum of an organization can be either static or dynamic, and a dynamic forum may be created automatically when a service issue is reported and the forum may be terminated after the issue is resolved.

Further, NSS 102 enables the interlinking of multiple collaboration workspaces and social networks to allow multiple private computer networks. The collaboration workspaces may collect descriptive private data about various entities such as employees, partners, or customers of an organization. As a result, the entities may interoperate through online partnerships and collaborations, and further may share the private data with trusted partners outside the organization. In an embodiment of the invention, the trust and data collaboration is enabled by using identity subsystem 202, GIS 206, and trust subsystem 208. NSS 102 may enable multiple levels of interconnection among the entities, organizations or computer networks based on trust.

In an embodiment of the invention, NSS 102 may allow information about the entities such as users and social application capabilities to traverse from outside the private computer network to the inside through multiple levels of trust and interconnection, without the requirement to get permissions. For example, in case of an organization a Chief Executive Officer (CEO) may set his/her preferred contact mode as a Public Relations (PR) assistant for the public network, as an administrative assistant for a controlled collaboration workspace or network, and as a personal assistant only to the private network. Therefore, people at different levels of access could get access to the CEO through appropriate channels automatically, without requesting for the permissions. In an embodiment of the invention, the preferences of the entities may be maintained in identity repository 204.

In an embodiment of the invention, the structure of collaborative workspaces may include networks at various levels: an internal network, an intermediary network and a public network of an organization/enterprise. Further, the entities of users can manage the profile information desired to be displayed at each of the workspaces. The information or fields viewable at the internal network level may be referred to as “inward facing profile”, the information or fields viewable at the intermediary network level may be referred to as “partner facing profile”, and the information or fields viewable at the public network level may be referred to as “outward facing profile”. The internal network may be the private enterprise network. Therefore, all collaboration internal to the organization may be performed within the internal network. Moreover, all entities or users can see internal profiles of all users of the internal network. The intermediary network may be a workspace where collaboration is performed with trusted partners of the entities or organizations. Further, external users may not be granted access to the internal network, but can see the outward profiles of internal users and are able to contact them on the intermediary network. Applications that are trusted may be allowed to execute in the intermediary network. The public network may be the workspace where external companies and users can connect with outward profiles of the entities. In an embodiment of the invention, the internal, intermediary and public networks may be social networks or workspaces for exchanging information or communication among the entities. An organization may host its own networks, or groups of organizations can form the networks, or an existing public network that is compliant with trust can be used.

In an embodiment of the invention, the permission to view complete profiles of the entities traverses from the internal network out to the public network, but not in the reverse direction. Therefore, the users on the level of intermediary network can view outward profiles and public profiles, but may not be able to view inward profiles of the users. In an embodiment of the invention, if a user wishes to introduce someone in the intermediary network to another user in the internal network, then an introduction and approval process through NSS 102 may be performed. NSS 102 may accordingly manage the identity information, geographical information and trust information of the users. For example, the CEO of an organization may make the PR department the outward facing connection that is the available to the public network, the administrative assistant the partner facing connection to the intermediary network, and provide direct access only to the internal network or friends in the internal network. Therefore, users at different levels could work through different people or NSS 102 that provides such services to receive direct access privileges. Further, NSS 102 may provide workspaces that include multi-organization forums. The multi-organization forums may be provided with customized trust models that may enable the organizations to securely search and locate for partnerships around valuable intellectual property, while putting less effort in managing confidentiality. In an embodiment of the invention, an email client of an entity may communicate with NSS 102 to determine identity information of another entity. For example, if a first entity receives an email from a second entity, then the first entity can configure the email client to determine the identity information of the second entity. In an embodiment of the invention, the first entity may right click the email address of the second entity in the email client and select a command such as “who is this?” from the contextual menu. Thereafter, the email client may communicate with mail transfer agents and/or NSS 102 to determine the identity of the second entity based on the email address and display the details. Further, as discussed above, the second entity may maintain multiple profiles such as “inward facing profile”, “partner facing profile”, “outward facing profile” and so forth. Therefore, NSS 102 may display a profile based on the preferences set by the second entity for the first entity.

NSS 102 may provide a taxonomy of meta-data that enables defining the collaboration or workspaces. For examples, the meta-data may be for duration such as task force group or standing group, goal, expertise, technology, organizations, quorum rules, creation mode, interaction patterns, process such as a-priori defined or problem-idea-decision, time such as synchronous versus asynchronous, location such as proximity, distributed, or mixed mode, and modification rights such as publish-only, publish-&-comment, or shared modification. In an embodiment of the invention, hardware and equipment such as, but not limited to, telephones, voice recording equipment in meeting rooms, or video conferencing may be used, and the recordings may be appended to the workspace as digital media files. Further, the appended files may be scanned, processed, and stored. For example, the files may be processed by using speech-to-text converter, and keywords extracted and stored. Therefore, the media or the files can be cataloged and indexed with such keywords as tags. Another example is to use a projector or interactive wall display to display videoconferencing images, with the inclusion of project tracking cues and timers, capacity for following directed processes visually presented, multi-voting through tagged smart pens, and so forth. As a result NSS 102 may be able to track distributed synchronous collaboration, in addition to asynchronous collaboration.

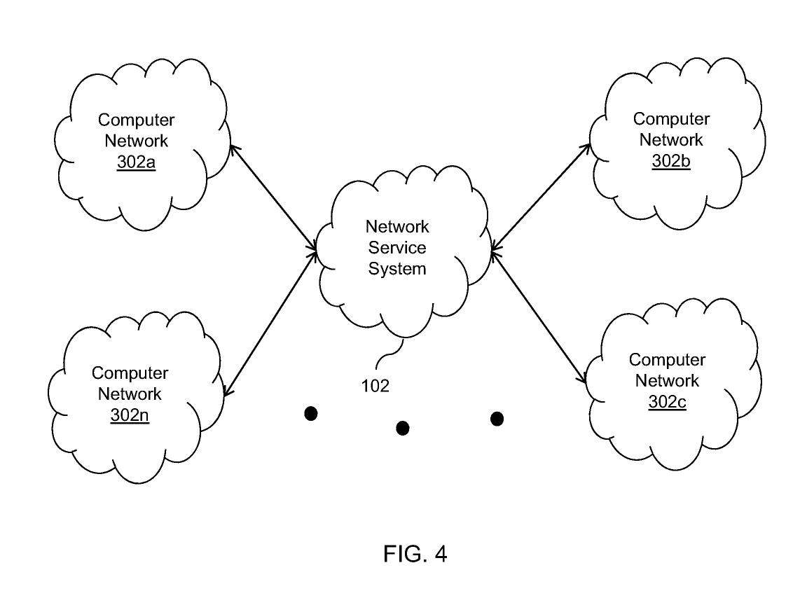

FIG. 4 illustrates an exemplary federated network 400, in accordance with an embodiment of the invention. Federated network 400 includes a cloud of network service systems 102 that may be connected to multiple computer networks 302a-n. Therefore, application software 220 may work with multiple numbers of processing nodes and extensive data. In an embodiment of the invention, the framework for application software 220 may be developed by using the JAVA programming language. In another embodiment of the invention, application software 220 may include by systems such as but not limited to, Representational State Transfer (REST), JavaScript Object Notation (JSON), remote portlets, web objects, and so forth.

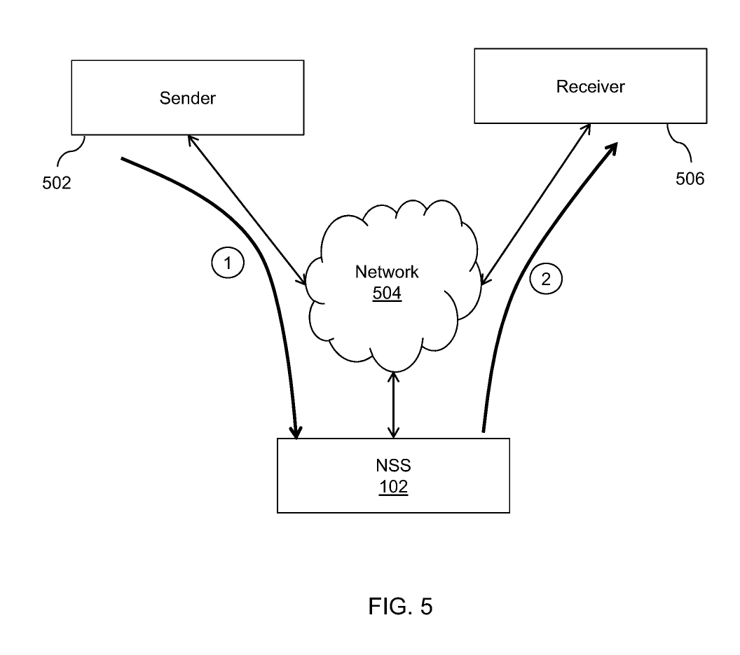

FIG. 5 is a flow diagram illustrating electronic communication by using NSS 102, in accordance with an embodiment of the invention. The electronic communication may include for example email messages. Typically, a sender 502 may send an email message to a receiver 506 over a network 504. Examples of sender 502 and receiver 506 may include a client, a server, a computer, a mobile phone and so forth. Further, sender 502 and receiver 506 may include application software such as mail transfer agents for sending and receiving the emails. However, in case the email address of receiver 506 is not correct or not available, then the email may never reach receiver 506. Further, receiver 506 may not desire to receive emails from sender 502 at all or at a particular email address. For example, sender 502 may be identified as an unauthorized sender (such as spammer), and therefore the mails from sender 502 may be undesirable to receiver 506. In an embodiment of the invention, NSS 102 may interoperate with the mail transfer agents for routing the email message based on the preferences of the sender and/or receiver. As shown by an arrow 1, the emails sent by sender 502 may be routed by the mail transfer agent to NSS 102 before forwarding to receiver 506. Thereafter, NSS 102 may process the email based on the preferences and accordingly forward the email to receiver 506 as shown by an arrow 2.

In an exemplary scenario, network manager 210 may receive a communication request such as an email from sender 502 and is destined for receiver 506. For example, name of receiver 506 is “John T. Smith”, email address may be “john.smith@abcbusiness.com”, a geographical address may be john.smith@123mainstreet.sanfrancisco.ca.us, and a universal unique identifier may be “John T. Smith rocket321”.

NSS 102 may process the email address to identify the universal unique identifier of receiver 506 based on the email address, by sending a query to identity subsystem 202. Further, the universal unique identifier of receiver 506 may be used to determine the preferences of receiver 506. For example, receiver 506 may have configured more than one email addresses, and may prefer to receive communication on an alternate email address that is different from the email address used by sender 502 to send the email. Moreover, the preferences may include authorization of sender 502 to communicate with receiver 506 and so forth. Subsequently, NSS 102 may forward the email to receiver 506 based on the preferences. Therefore, undeliverable and/or bounced emails may be delivered by NSS 102 by using predefined rules and/or preferences for forwarding and permission. In an embodiment of the invention, NSS 102 may use trust subsystem 208 to authenticate the communication. For example, trust subsystem 208 may encrypt the communication, encrypt the attachments such as files in the email, create date and time stamps for the communication, or may perform other processes required to authenticate the communication.

In another exemplary scenario, sender 502 may address and send an electronic message to a geographical address such as “john.smith@123mainstreet.sanfrancisco.ca.us” of receiver 506. Thereafter, NSS 102 may check whether the address is active, and deliver it according to the predefined rules and preferences. In an embodiment of the invention, the postal authority may print out the email or perform a voice to text conversion of voicemail, and place it in a physical package for delivery based on the above address. Therefore, NSS 102 may be used to forward a geographically addressed email to a preferred address of receiver 506. Further, the printout/conversions may be further simplified by including a barcode and a reply section for handwritten responses, which can later be scanned and used as a physical-to-electronic reply method.

In yet another exemplary scenario, a sender may send a physical letter/package that may be addressed with only an email address of the receiver. In this case, the postal system may query identity subsystem 202 to get physical address of the receiver. Thereafter, the physical address may be annotated onto the physical letter/package and forward the same to the receiver though typical post. Further, if the sender addressed the physical letter/package with a geographical address, such as: “john.smith@123mainstreet.sanfrancisco.ca.us”, then the postal system may again follow the same process. In an embodiment of the invention, delivery locations and preferences can be set in real time by the receivers. Exemplary rules in the preferences of the receiver are shown with reference to Table 1 below:

TABLE 1

| | Physical | Electronic | Realtime | Certified | Unauthenticated |
|---|---|---|---|---|---|
| Urgent | Deliver to | Forward to | | | |
| | 123 Main | john.smith@abcbiz.com. | | | |
| | Street with | | | | |
| | email alert. | | | | |
| | Use ICQ | Log receipt | Query | | |
| | messaging | verification into | | | |
| | channel: | e-vault. | | | |
| | 234958320 | | | | |
| First | Same | Same | Same | Same | Allow |
| Class | | | | | |
| Parcel | Forward to | If less than ‘N’ | | | Allow, with virus |
| | POBox 123 | MB, send to | | | scan |
| | | jsmith@wireless.com, | | | |
| | | otherwise to | | | |
| | | same. | | | |
| Bulk | Deny | Compensated | Deny | Accept if | Deny |
| class | | adlet model, | | donation of | |
| | | forward to | | $ ‘N’ is | |
| | | amkt:jsmith.saneone.com. | | made to | |
| | | | | charitable.com | |

As shown in Table 1, the communication may be divided in various categories such as urgent, first class, parcel, bulk class and so forth. In an exemplary scenario as shown in table 1, an urgent communication that is physical is nature may be delivered to a “123 Main Street” address of the receiver, while the electronic communication may be forwarded to an email address “john.smith@abcbiz.com”. Similarly, for a communication marked as parcel, if physical may be send to a “PO Box 123”, while a mail with less than ‘N’ MegaByte (MB) of size may be forwarded to an email address “jsmith@wireless.com”. For example, N may be 1 MB or any other size preferred by the entity. Further, the authentication may be set to allow after a virus scanning of the email.

In an embodiment of the invention, NSS 102 may scan for violations, complaints, errors and problems within NSS 102 to correct, log and manage negative conditions. These may be maintained at trust subsystem 208. In an embodiment of the invention, a server may be used to maintain the scanned violations, complaints, errors, problems and so forth.

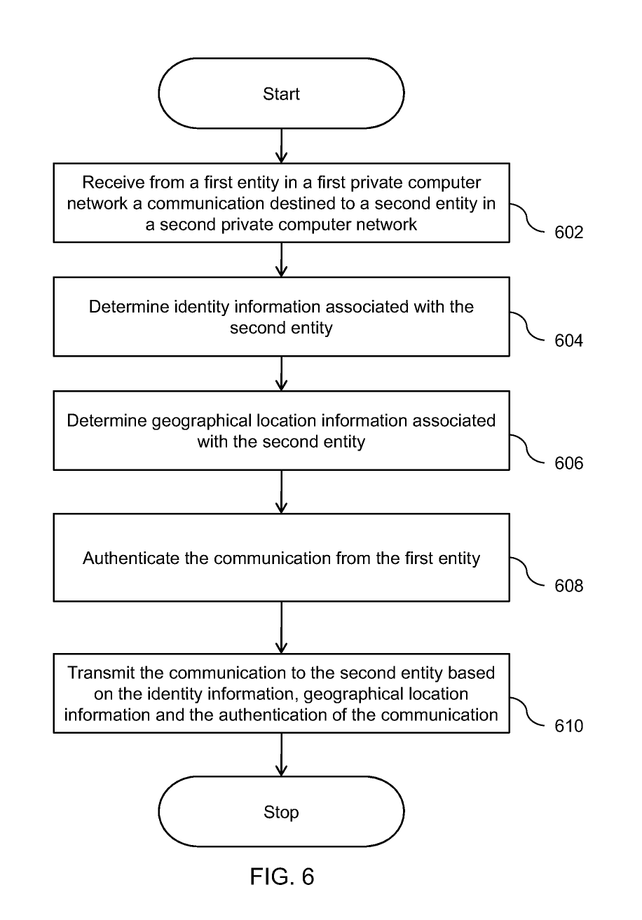

FIG. 6 is a flowchart of a method for providing services in a network, in accordance with an embodiment of the invention. The services may be provided by NSS 102. At step 602, a communication may be received from a first entity in a first private computer network. The communication may be destined to a second entity in a second private computer network. The first private network and the second private network may not be able to communicate directly with each other. For example, the first private network may be an intranet or a social network of an organization, and the second private network may be the intranet or the social network of another organization that are not accessible to entities outside the network. The communication may be for example, but not limited to, an email, a file, a file sharing request, an Internet message and so forth. In an embodiment of the invention, the communication may be received at NSS 102. Thereafter, at step 604, identity information associated with the second entity may be determined. The identity information may be determined at identity subsystem 202. For example, identity subsystem 202 may include a unique universal identifier for the second entity.

At step 606, geographical location information associated with the second entity may be determined. The geographical information may be determined at GIS 206. For example, GIS 206 may include location information such as, but not limited to, a physical address, country, state, zip and so forth, corresponding to the unique universal identifier of the second entity. Subsequently, the communication from the first entity for the second entity may be authenticated. The authentication may be performed at trust subsystem 208. In an embodiment of the invention, authentication may be performed based on rules in the predefined preferences associated with the second entity. Thereafter, at step 610 the communication may be transmitted to the second entity based on the identity information, geographical location information and the authentication of the communication. In an embodiment of the invention, the communication may be transmitted by NSS 102. Therefore, the first entity and the second entity can communicate in a secure manner and based on the predefined preferences even across private computer networks. Further, the private computer networks are federated for communication and/or collaboration based on the services provided by NSS 102.

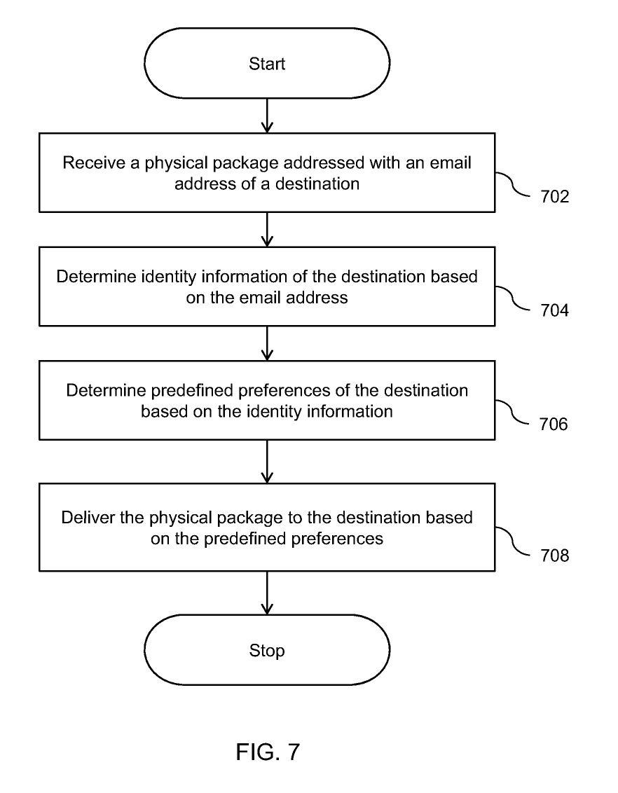

FIG. 7 is a flowchart of a method of delivering a physical package, in accordance with an embodiment of the invention. Typically, in postal services, a sender may send a physical package to a receiver or a destination. In such a case, the sender may provide information such as the physical address of the receiver. However, the receiver may be not be available at the address mentioned on the physical package, or the address may not be up-to-date. As a result, the receiver may not be able to receive the physical package. Further, in some cases, the receiver may desire to receive the physical package based on his predefined preferences. Exemplary preferences are explained in conjunction with the table 1 above. The present invention enables the sender to send the physical package by providing the email address of the receiver. Further, the receiver may receive the physical package based on the rules in the predefined preferences.

At step 702, a physical package may be received from a sender. In an embodiment of the invention, the physical package may be received at a postal services provider. Further, the physical package may be addressed with an email address of the receiver. In an embodiment of the invention, the package may be addressed with both an email address and a physical address of the receiver. Thereafter, at step 704, identity information of the receiver is determined based on the email address. The identity information may be determined by using identity subsystem 202 of NSS 102. At step 706, predefined preferences of the receiver may be determined based on the identity information. In an embodiment of the invention, the predefined preferences may be determined from trust subsystem 208. In an embodiment of the invention, the physical package may be marked with information associated with the sender. For example, the physical package may be marked with an address, name, email address or any other details of the sender. The information associated with the sender may be required to authenticate the physical package from the sender. The predefined preferences may include rules for delivering the physical package based on the category of the physical package, authentication of the sender, and so forth. Subsequently, at step 708, the physical package may be to the receiver based on the predefined preferences.

In an embodiment of the invention, the sender may address the physical package with a bar code or a Radio Frequency Identification (RFID) chip containing the information about the receiver. Therefore, the bar code may then be scanned to receive information such as the predefined preferences of the receiver.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A network service system for providing services to a plurality of entities through a network, comprising:
at least one identity subsystem configured to manage identity information associated with the plurality of entities;
at least one geographical information subsystem configured to manage information associated with geographical location of the plurality of entities; and
at least one trust validation subsystem configured to authenticate the communication among the plurality of entities based on predefined rules; and
a network manager configured to communicate with one or more of the at least one identity subsystem, the at least one geographical location subsystem, the at least one trust validation subsystem and the plurality of entities to provide the services.

2. The system of claim 1, wherein the information associated with geographical location comprises a geographical address associated with each of the plurality of entities.

3. The system of claim 1, wherein the identity information comprises at least one of a name, photograph, one or more email address(s), or a universal identifier associated with each of the plurality of entities.

4. The system of claim 1, wherein the network manager communicates with the at least one identity subsystem to receive the identity information of one or more of the plurality of entities.

5. The system of claim 1, wherein the services include federation of a plurality of private computer networks that include the plurality of entities.

6. The system of claim 1, wherein the services include providing secure communication among the plurality of entities.

7. The system of claim 1, wherein the trust validation system is further configured to:
maintain a time information associated with the communication;
encrypt the communication based on a predefined preference; and
verify a security level of the communication.

8. the system of claim 1, wherein communication comprises one or more files.

9. A system for federating a plurality of private computer networks, the system comprising:
at least one identity subsystem configured to maintain identity information of a plurality of entities, wherein the plurality of entities are associated with at least one of the plurality of private computer networks, wherein the plurality of entities communicate through the plurality of private computer networks;
at least one geographical information subsystem configured to maintain information associated with geographical location of the plurality of entities; and
at least one trust validation subsystem configured to maintain an authentication of the plurality of entities, wherein the plurality of entities communicate among each other based on the identity information, geographical location and the authentication of the communication.

10. The system of claim 9, wherein the information associated with geographical location comprises a geographical address associated with each of the plurality of entities.

11. The system of claim 9, wherein the identity information comprises at least one of a name, photograph, one or more email address(s) or a universal identifier associated with each of the plurality of entities.

12. The system of claim 9, wherein the communication comprises one or more electronic messages.

13. The system of claim 9, wherein the trust validation system is further configured to:
maintain a time information associated with the communication;
encrypt the communication based on a predefined preference; and
verify a security level of the communication.

14. The system of claim 9, wherein communication comprises one or more files.

15. The system of claim 14, wherein the trust validation system is further configured to verify the security level of the one or more files.

16. A network service system for providing services to a plurality of entities through a network, the system comprising:
at least one identity subsystem configured to manage identity information associated with the plurality of entities;
at least one geographical information subsystem configured to manage information associated with geographical location of the plurality of entities; and
at least one trust validation subsystem configured to authenticate the communication among the plurality of entities based on predefined preferences of the entities; and
at least one processor; and
a memory comprising instructions executable by the at least one processor, the instructions comprising:
receiving communication from a first entity from the plurality of entities for a second entity from the plurality of entities;
determining identity information of the second entity from the identity subsystem;
determining information associated with geographical location of the second entity from the geographical location subsystem;
authenticating, by the at least one trust subsystem, the communication from the first entity for the second entity, based on the determined identity information, geographical location and predefined preferences of the second entity; and
transmitting the communication to the second entity based on the authentication.

17. The system of claim 16, wherein the information associated with geographical location comprises a geographical address associated with each of the plurality of entities.

18. The system of claim 16, wherein the identity information comprises at least one of a name, photograph, one or more email address(s), or a universal identifier associated with each of the plurality of entities.

19. The system of claim 16, wherein the services include federation of a plurality of private computer networks that include the plurality of entities.

20. The system of claim 16, wherein the services include providing secure communication among the plurality of entities.

21. The system of claim 16, wherein the trust validation system is further configured to:
maintain a time information associated with the communication;
encrypt the communication based on a predefined preference; and
verify a security level of the communication.

22. The system of claim 16, wherein communication comprises one or more files.

23. A system for federating a plurality of private computer networks, the system comprising:
at least one identity subsystem configured to maintain identity information of a plurality of entities, wherein the plurality of entities are associated with at least one of the plurality of private computer networks, wherein the plurality of entities communicate through the plurality of private computer networks;
at least one geographical location subsystem configured to maintain information associated with geographical location of the plurality of entities;
at least one trust validation subsystem configured to maintain an authentication of the plurality of entities;
at least one processor; and
a memory comprising instructions executable by the at least one processor, the instructions comprising:
receiving communication from a first entity from the plurality of entities for a second entity from the plurality of entities;
determining identity information of the second entity from the identity subsystem;
determining information associated with geographical location of the second entity from the geographical location subsystem;
authenticating, by the at least one trust subsystem, the communication from the first entity for the second entity, based on the determined identity information, geographical location and predefined preferences of the second entity; and
transmitting the communication to the second entity based on the authentication.

24. The system of claim 23, wherein the information associated with geographical location comprises a geographical address associated with each of the plurality of entities.

25. The system of claim 23, wherein the identity information comprises at least one of a name, photograph, one or more email address(s) or a universal identifier associated with each of the plurality of entities.

26. The system of claim 23, wherein the communication comprises one or more electronic messages.

27. The system of claim 23, wherein the trust validation system is further configured to:
maintain a time information associated with the communication;
encrypt the communication based on a predefined preference; and
verify a security level of the communication.

28. The system of claim 23, wherein communication comprises one or more files.

29. The system of claim 28, wherein the trust validation system is further configured to verify the security level of the one or more files.

30. A federated computer network comprising:
a plurality of private computer networks, wherein each of the plurality of computer networks comprise a plurality of entities;
at least one identity subsystem configured to maintain identity information of the plurality of entities;
at least one geographical location subsystem configured to maintain information associated with geographical location of the plurality of entities;
at least one trust validation subsystem configured to authenticate the communication among the plurality of entities based on predefined rules; and
a network manager configured to enable communication among the plurality of entities associated with one or more of the plurality of private computer networks, based on information received from one or more of the at least one identity subsystem, the at least one geographical location subsystem, and the at least one trust validation subsystem.

31. The system of claim 30, wherein the identity information comprises at least one of a name, photograph, one or more email address(s) or a universal identifier associated with each of the plurality of entities.

32. A computer-implemented method for federating a plurality of private computer networks, the method comprising:
receiving from a first entity in a first private computer network a communication destined to a second entity in a second private computer network;
determining, at an identity subsystem, identity information associated with the second entity;
determining, at a geographical location subsystem, geographical location information associated with the second entity; and
authenticating, at a trust subsystem, the communication from the first entity; and
transmitting the communication to the second entity based on the identity information, geographical location information and the authentication of the communication.

33. The computer-implemented method of claim 32, wherein the authentication is performed based on the predefined preferences of the second entity.

34. The computer-implemented method of claim 32, wherein the geographical location information comprises a geographical address associated with each of the plurality of entities.

35. The computer-implemented method of claim 32, wherein the identity information comprises at least one of a name, photograph, or a universal identifier associated with each of the plurality of entities.

36. A method for delivering a physical package, comprising:
receiving, from a sender, the physical package, wherein the physical package is addressed with an email address of a receiver;
determining identity information of the receiver based on the email address;
determining predefined preferences of the receiver based on the identity information; and
delivering the physical package to the destination based on the predefined preferences.

37. The method of claim 36, wherein the physical package is further marked with information associated with the sender.

38. The method of claim 37, wherein the predefined preferences comprise one or more rules for receiving the physical package based on the information of the sender.

39. The method of claim 38, wherein the predefined preferences comprise one or more rules for receiving the physical package based on a category of the physical package.

40. The method of claim 38, wherein the identity information is received from an identity subsystem.

41. The method of claim 38, wherein the predefined preference are received from a trust subsystem.
